(19) United States
(12) Patent Application Publication
(10) Pub. No.: US 2007/0133942 A1
(43) Pub. Date: Jun. 14, 2007

(54) Reproduction of a trick play signal

(75) Inventors: Eric Wilhelmus Josephus Moors, Eindhoven (NL); Albert Maria Arnold Rijckaert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/579,417

(22) PCT Filed: Nov. 10, 2004
(86) PCT No.: PCT/IB04/52375

§ 371 Date: May 15, 2006

(30) Foreign Application Priority Data
Nov. 18, 2003 (EP) 03104251.8

(51) Int. Cl. H04N 5/91

(52) U.S. Cl. 386/68

(57) ABSTRACT

A trick play signal is derived from a stored, and typically encrypted video stream. The video stream comprises data representing a series of I frames and P or B frames encoded at a variable bit rate, the I-frames being decodable independent of any other frame, decoding of the P or B frames requiring reference to other frames. Selected segments of data are retrieved from the video stream. Each segment corresponds to a part of data from the stream with a selected length. Distances between successive retrieved segments are selected dependent on a trick play speed. A trick play video signal is generated that comprises an earliest first frame from each respective segment. Stream specific properties of the stream are determined that are indicative of a rate at which the I-frames occur in the stream. The selected length for use in said selective retrieving is computed from the properties that have been determined, so that on the basis of the properties the segments of said selected length are predicted to include data representing at least one whole first frame at least on average.

The invention relates to a method of reproducing a trick play signal from a stored encrypted video stream, and an apparatus with the capability of such a reproduction.

A conditional access video stream is conventionally broadcasted as an MPEG transport stream. Such a stream contains series of packets of encrypted data. The data encodes a series of video frames, in the form of so called I-frames, P-frames and B-frames. The P-frames and B-frames are encoded as changes with respect to nearby video frames in the series. The I-frames are encoded independently of other frames. During normal reproduction each packet is first decrypted. Next the frames are decoded (decompressed) from the decrypted data.

When a conditional access video stream is stored in a storage medium such as a magnetic or optical disk, it is also possible to reproduce the stream in a trick play mode, for example at a higher than normal reproduction speed, or in reverse direction. During trick mode reproduction, only selected frames are displayed on a display screen. Conventionally only selected I-frames are displayed.

In theory reproduction in trick play mode could be realized by retrieving, decrypting and decoding the entire stream, and subsequently selecting frames for trick mode display from the decoded stream. In practice, however, this would place excessive and useless demands on decoding, since the frames would have to be decoded at a much higher rate than normal and only part of the frames would be used.

Therefore, one preferably decrypts and decodes only segments of data from the stream that represent the frames that will actually be displayed, which forms a subset of all frames. In particular, one should preferably decrypt and decode only segments of data from the stream that represent (selected) I-frames. In the case of a variable bit rate stream such as an MPEG stream it is difficult, however, to select only the data that represents the necessary frames, because the data has to be retrieved and decrypted before it can be determined from the data where the I-frames are located.

As a result one has to retrieve and decrypt unnecessary data in order to search for the necessary data. Data preceding the necessary data has to be retrieved and searched to make sure that the necessary data is not missed. Due to pipelining it is usually even necessary to retrieve and decrypt data that follows the necessary data, since the necessary data is identified with a delay, during which the following data has to be retrieved and decrypted “just in case”.

Various solutions have been proposed to this trick play problem, mainly involving ways of making the data that represents I-frames more easily recognizable. For example, European patent application No 1150497 describes a stream in which recognizable marker packets are inserted around packets with data that represents I-frames. PCT Patent application No. WO 02/15579 describes storing headers of I-frames without encryption, so that these can be more easily identified. US patent application No. 2002/0116705 describes storing a table with information about the location of I-frames. However, all these solutions require storing modifications of the stream or additional data. It is not possible to work with a stored broadcast stream that was intended for normal play.

Among others, it is an object of the invention to enable trick mode replay of a stream, displaying frames from only a subset of the data in the stream, without requiring information that identifies data segments that represent specific frames before these data segments have been retrieved and/or decrypted.

The invention provides for a method of reproducing a trick play signal derived from a stored encrypted video stream, wherein the encrypted video stream comprises data representing a series of first and second frames encoded at a variable bit rate, the first frames being decodable independent of any other frame, decoding of the second frames requiring reference to other frames. Selected segments of the stream are loaded from a storage device for use in trick play mode display. The length of the segments is computed on the basis of the properties that have been measured from the stream, so that the segments of the selected length are predicted to include data representing at least one whole first one of the frames at least on average. The earliest first frame from each segment is used for decoding and display in the trick play mode. Thus, the amount of data that is retrieved is adapted to the properties of the stream.

Preferably, only properties of the stream are used that can be determined without en decryption. Thus, retrieval can be controlled in a part of the apparatus that does not need to be secure against hacking. In an embodiment the segment length is computed prior to selectively retrieval of the segments, from an estimated rate of frames per unit of stream length based on a ratio between an intermediate stream size between points in the stream that are separated by more than a multiple of the selected length, and a difference between time values, such as PCR time values, associated with these points in the stream. As an alternative, time stamps associated with points in the stream, such as packets that contain ECM data may be used. Such timestamps may be obtained for example by observing time values for the time point of reception at which different parts of the stream are received before storage.

Preferably the selected length is adapted dynamically after said initial computing. In one embodiment this is realized adaptive to an observed length of data from a start of a segment to a first following data representing a whole one of the first ones of the frame. In another embodiment the selected length is regulated after the initial computation, so that on average each segment contains a predetermined, possibly non-integer, average number of first frames.

Preferably a distance between starting points of successive segments is selected dependent on a selected trick play speed and a distance between the first frames in the stream that follows from said properties. Thus, selectable trick play speeds may be used that are not limited to integer speed factors relative to a normal play speed.

These and other objects and advantageous aspects of the invention will be described in more detail using the following figures.

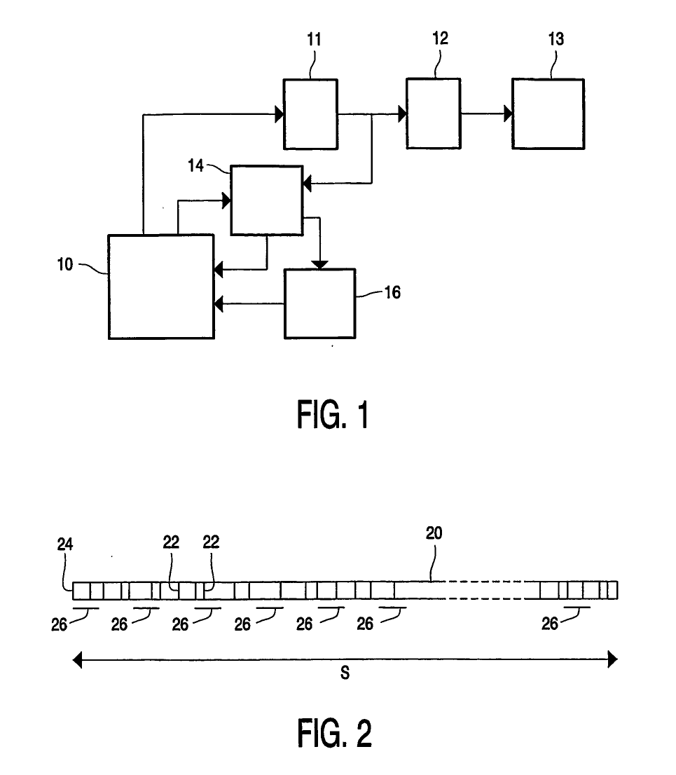

FIG. 1 shows an apparatus for reproducing a video stream

FIG. 2 symbolically shows a stream

FIG. 1 shows an apparatus for reproducing a video stream. The apparatus contains a hard disk storage device 10, with a data output coupled to a cascade of a decryption unit 11, a decoder 12 and a display unit 13. In addition the apparatus contains a segment length computation unit 14 and an access controller 16. Segment length computation unit 14 is coupled to storage device 10 and has an output coupled to access controller 16. Optionally segment length computation unit 14 has an input coupled to an output of decryption unit 11. Access controller 16 has an output coupled to an input of storage device 10.

In operation at least one encrypted stream of MPEG video information is stored in storage device 10. Access controller 16 causes storage device 10 to retrieve a series of selected segments of data of selected length from the stream. This may be realized, for example, by supplying a series of segment starting addresses and segment length information to storage device 10, or alternatively by supplying a series of sector and/or track addresses, starting from the address corresponding to the segment starting address and continuing with sector and/or track addresses until data from a segment of the selected length has been retrieved. Storage device 10 supplies the data from the selected segments to decryption unit 11, which decrypts compressed video data from the segments and supplies the decrypted data to decoder 12. Decoder 12 decompresses the data and generates video information, which is supplied to display unit 13 for display.

Decoder 12 is arranged to reproduce the video stream in a trick play mode, i.e. a stream with an abnormal play rate, such as fast forward at for example 2, 4, 8, or 16 times the normal play rate, or at a variably adjustable rate or at a reverse play rate. During trick play, decoder 12 searches the data from each segment for specific data that represents the first occurring I frame in each segment and outputs only that frame from the stream after decompression.

Decoder 12 may be realized as a two part structure: a trick play preprocessor, which is arranged to extract the first occurring I frames and to generate an MPEG output stream in which the video information consists of only the extracted I frame, and a conventional MPEG decoder for decoding the stream. In this case the trick play processor may be bypassed in the normal play mode. In this embodiment, the trick play processor, may generate new groups of pictures, each containing an extracted I-frame and or more newly generated “empty” P and/or B frames, which do not add any change to the I frames. The total number of frames T in such a new group of pictures need not be equal to the number of frames in groups of pictures from the original stream. When the stream contains only I-frames, a problem may arise that the average data rate (average number of bits per second of reproduction) is too large for a transport channel or decoder. By including “empty” P or B frames the data rate is reduced. Of course the fraction of I frames that is selected from the stream must be reduced accordingly by a factor T.

Before the start of reproduction in the trick play mode segment length computation unit 14 computes the length of the segments that have to be retrieved from storage device 10 and signals this length to access controller 16. Subsequently access controller 16 causes storage device 10 to retrieve segments having this computed length. Optionally segment length computation unit 14 subsequently adapts the segment length dependent on decrypted data from decryption unit 11.

FIG. 2 symbolically represents an encrypted video stream as a function of time as an elongated block 24 to help illustrate the computation of the initial segment length. The locations in the stream of the start of packets with the start of I-frames have been indicated by vertical lines 22 (only two explicitly referenced). Between the start locations the stream may contain packets with the remainder of the I-frame, P-frame data, B-frame data and other data. Segments 26 have been indicated. During replay access controller 16 fetches only the data from the stream that belongs to these segments 26. It should be noted that the segments 26 have a length that is set so that, irrespective of the location of the start of the segment, almost each segment contains at least one complete I-frame.

Stream 24 contains packets with PCR's (Program Clock References) that are not encrypted. (PCR's are known per se. They are provided to enable a receiving apparatus to generate a clock counter, that assumes values corresponding to the received PCR values approximately when PCR's are received. The stream contains other data, such as a PTS (Presentation Time Stamp) to indicate that data associated with the PTS should be output when the clock counter corresponds to the PTS value). PCR's are preferably used because the packets that contain the PCR are usually not encrypted.

Before the start of reproduction in the trick play mode segment length computation unit 14 retrieves parts of the stream from mutually distant locations in the stream and extracts a first PCR value and a second PCR value from these parts. The mutually distant location are typically separated by many frames in the stream, preferably at the start and the end of the stream, typically at least many thousands of frames apart, but at least several seconds of playing time apart. Segment length computation unit 14 determines the total length S of data in the stream between the locations from which the first and second PCR have been retrieved. From this data segment length computation unit 14 computes an average GOP size (GOP=a Group Of Pictures, which comprises one I-frame and adjacent frames that are encoded dependent on that I frame):
average GOP size=S/{(T2−T1)*frame rate/frames per GOP}

Here T1 and T2 are the times encoded by the first and second PCR respectively. The frame rate is a known number (e.g. 25 frames per second in Europe) and (T2−T1)*frame rate is the total number of frames in the time interval from T1 to T2. “Frames per GOP” is a number that represents the average number of frames (I-frame, P-frames and B-frames) in a GOP. This number usually is a constant number in a stream, typically twelve or sixteen. Access controller 16 uses a number equal to the computed average GOP size plus the maximum I-frame size as initial segment length for fetching successive segments from storage device 10.

Alternative solutions exist for selecting segment size. In another embodiment data segment length computation unit 14 uses time stamped ECM packets to compute T1, T2 values instead of PCRs. ECM's are well known per se. ECM's (Entitlement Control Messages) are transmitted changed every few seconds and contain control words for decrypting the stream. Necessarily ECM's are readily recognizable as ECM's without decryption. Time stamped ECM's contain a time stamp, or are associated with a time stamp of reception of the ECM when it was stored in storage device 10. Data segment length computation unit 14 may use the time stamps from the ECM's to estimate (T2−T1) for the computation of the segment size. In this case, of course, data segment length computation unit 14 uses the length of the data S between the ECM's from which the times T2, T1 are obtained.

In an embodiment the number of frames in a GOP may be determined by decrypting part of the stream and counting the number of frames between successive I-frames. Alternatively, this number may be adapted dynamically, by increasing this number when a percentage of segments that does not contain an I-frame exceeds a threshold value.

Access controller 16 selects the distance between the starting points of the segments dependent on the selected trick play mode (the distance between the starting point need not be an integer number of segment lengths). Thus, it is ensured that at least almost each segment contains an I-frame, so that this I-frame can be extracted from the segment, after decryption, for display in the trick play mode. When a segment is found not to contain an I-frame, display of a previous I-frame may be repeated for example. As long as this does not occur very frequently, display in the trick play mode is not significantly visibly affected thereby.

Preferably, the distance between the starting addresses of the segments that access controller 16 retrieves from storage device is adapted to the stream and the trick play speed. Data segment length computation unit 14 may compute this distance as well, using for example the formula
distance=distance in frames*average frame length

Here the number “distance in frames” equals the trick play speed factor relative to the normal play speed. When an intermediate stream is generated to represent the stream at trick play speed and empty frames are added so that the intermediate stream contains groups of T pictures, the distance in frames must be multiplied by the factor T. The average frame length is computed for example from
average frame length=S/{(T2−T1)*frame rate)}

It should be noted that this distance computation does not require a specific or even an integer “distance in frames” (trick play speed). As a result, arbitrarily selected or variably adjustable trickplay speeds may be supported, not just a predetermined set of trick play speeds such as 2, 4, 8, 16. Preferably, the apparatus is provided with a user interface (not shown) to select the trick play speed that is used in this computation.

Preferably, data segment length computation unit 14 adapts the data segment length dynamically during replay. This may be realized for example by detecting for a number of data segments the run-up distance from the start of respective data segments to the end of the data that encodes the first I-frame. In an embodiment data segment length computation unit 14 adapts the segment length such that it exceeds the average of this run-up distance by a predetermined factor, e.g. 1.5. Of course, instead of the run-up distance to the end of the data that encodes the first I-frame, other measures may be used such as a run-up distance to the start of the I frame etc. In another embodiment data segment length computation unit 14 determines the number of I-frames in each data segment and regulates the segment length in a feedback loop so that on average the number of I-frames equals a predetermined value e.g. 1.0 (or 1.2 etc.). Any conventional type of feedback loop may be used for this purpose.

Detection of the I frames for the purpose of adaptation of the segment length may of course be realized by parsing of the decrypted data in the segments, or detecting that such a segment has been parsed by the decoder. Preferably, however, use of decrypted data is avoided. In one embodiment, the adaptation makes use of the identification of PES (Packetized Elementary Stream) packets. Packets in an MPEG stream contain a payload unit start indicator or “plusi” bit to indicate whether the packet contains a PES header. In an embodiment each GOP is contained in a respective one of the PES packets. In this case, the number of packets that is identified to contain a PES header, or the distance from the start of the data segment to the packet with the PES header (detect from a plusi bit) may be used for adaptation, analogously to the number of I frames or the distance to the first I frame. In another embodiment each frame is contained in a respective one of the PES packets. In this case number of packets that is identified to contain a PES header divided by the GOP size, or the distance from the start of the data segment to the n^{th} packet with the PES header (n being the GOP size) may be used for adaptation, analogously to the number of I frames or the distance to the first I frame. In case of a stream where the relation between PES headers and frames or GOP's is unknown, but fixed, a selection may be made to use one form of adaptation or another, dependent on the observed average frequency of PES headers, selecting one form of adaptation for example if the PES headers occur at an average frequency corresponding to GOP's and another if the average frequency corresponds to single frames.

It will be appreciated that the use of a plusi bit, or PES headers for this purpose is merely one example. Any other repetitive characteristic feature of the encrypted stream whose frequency is correlated with the frequency of I frames may be used to control adaptation.

It should be appreciated that preferably the apparatus of FIG. 1 is a single apparatus, but that without deviating from the invention the apparatus may be split into different apparatuses, for example, into a storage retrieval apparatus, which performs the data segment length selection function and outputs segments of the selected length, a decryption apparatus, and a decoding and display apparatus. Also any combination of such apparatuses may be used. Moreover, the storage retrieval apparatus may be a remote apparatus, connected to the decryption and decoding apparatus via a network, or a wireless connection. The various units in the apparatus can be implemented as dedicated hardware devices, but also as suitably programmed computers. In this case, different functions may be performed by executing the appropriate different programs on the same computer on or different computers.

A person skilled in the art will appreciate that all elements of the embodiment of the apparatus can e implemented in software modules, thus forming a computer programme enabling a computer to be programmed to perform the embodiment of the method according to the invention that can be carried out by the apparatus shown by FIG. 1. The computer programme can be stored on a carrier like a CD-ROM, DVD, harddisks or solid state memory like Flash EEPROM

The invention can be summarized as follows:

A trick play signal is derived from a stored, and typically encrypted video stream. The video stream comprises data representing a series of I frames and P or B frames encoded at a variable bit rate, the I-frames being decodable independent of any other frame, decoding of the P or B frames requiring reference to other frames. Selected segments of data are retrieved from the video stream. Each segment corresponds to a part of data from the stream with a selected length. Distances between successive retrieved segments are selected dependent on a trick play speed. A trick play video signal is generated that comprises an earliest first frame from each respective segment. Stream specific properties of the stream are determined that are indicative of a rate at which the I-frames occur in the stream. The selected length for use in said selective retrieving is computed from the properties that have been determined, so that on the basis of the properties the segments of said selected length are predicted to include data representing at least one whole first frame at least on average.

1. A method of reproducing a trick play signal derived from a stored video stream, wherein the video stream (20) comprises data representing a series of first frame (22) and second frames encoded at a variable bit rate, the first frames (22) being decodable independent of any other frame, decoding of the second frames requiring reference to other frames, the method comprising
selectively retrieving segments (26) of data from the video stream (20), each segment (26) corresponding to a part of data from the stream (20) with a selected length, with distances between successive retrieved segments (26) selected dependent on a trick play speed;
generating a trick play video signal that comprises an earliest first frame (22) from each respective segment;
determining stream specific properties of the stream (20) that are indicative of a rate at which the first frames (22) occur in the stream (20);
computing the selected length for use in said selective retrieving from the properties that have been determined, so that on the basis of the properties the segments (26) of said selected length are predicted to include data representing at least one whole first frame (22) at least on average.

2. A method according to claim 1, wherein said determining comprises computing the selected length initially, prior to said selectively retrieving, from an estimated rate of a number of frames per unit of stream length based on a ratio between an intermediate stream size between points in the stream (20) that are separated at least a multiple of first frames (22), and a difference between time values that the stream associates with these points.

3. A method according to claim 2, wherein said determining comprises adapting the selected length after said initial computing, concurrently with said selective retrieving of the segments (26), adaptive to an observed length of data from a start of a segments to a first following data representing a whole one of the first frames (22).

4. A method according to claim 2, wherein said determining comprises regulating the selected length after said initial computing, the selected length being regulated so that on average each segment (26) contains a predetermined possibly non-integer average number of first frames (22).

5. A method according to claim 2, wherein said determining comprises
determining a difference between time references that indicate relative playing time instants of data from mutually spaced points in the stream (20), the difference being indicative of a number of frames between the points, given a frame rate of the stream;
determining a total length of data between said points;
said computing comprising computing the selected length in proportion to a ratio of the total length and the number of frames between the points.

6. A video stream storage and reproduction apparatus, comprising
a storage device (10) for storing a video stream (20), wherein the video stream (20) comprises data representing a series of first frames (22) and second frames encoded at a variable bit rate, the first frames (22) being decodable independent of any other frame, decoding of the second frames requiring reference to other frames,
an access control device (16) arranged to retrieve segments (26) from the storage device (10), for supplying the segments (26) to a decoding device (11) for use in trick mode display, a distance between successive segments (26) being selected dependent on the trick play speed, the segments (26) each containing a part of the of data with a selected segment length;
a data segment length selection unit (14) arranged to determine stream specific properties of the stream (20) that are indicative of a rate at which the first ones of the frames (22) occur in the stream (20), and to select the selected segment length for use in the trick play mode from said properties, so that on the basis of the properties the segments of said selected length are predicted to include data representing at least one whole first frame at least on average.

7. A video stream storage and reproduction apparatus according to claim 6, wherein the access control device (16) is arranged to select the distance between starting points of successive segments dependent on a selected trick play speed and a distance between the first frames (22) in the stream (20) that is derived from said properties.

8. A video stream storage and reproduction apparatus according to claim 7, having a control interface for selecting the trick play speed, selectable trick play speeds not being limited to integer speed factors relative to a normal play speed.

9. A video stream storage and reproduction apparatus according to claim 6, wherein said selection of the selected data segment length comprises computing the selected length initially, prior to said selectively retrieving, from an estimated rate of frames per unit of stream length based on a ratio between an intermediate stream size between points in the stream (20) that are separated by at least a multiple of first frames (22), and a difference between presentation times that the stream (20) associates with these points.

10. A video stream storage and reproduction apparatus according to claim 9, wherein said selection of the data segment length comprises adapting the selected length after said initial computing, concurrently with said selective retrieving of the segments, adaptive to an observed length of data from a start of a segment (26) to a first following data representing a whole one of the first frames (22).

11. A video stream storage and reproduction apparatus according to claim 9, wherein said selection of the data segment length comprises regulating the selected length after said initial computing, the selected length being regulated so that on average each segment contains a predetermined possibly non-integer average number of first frames (22).

12. A video stream storage and reproduction apparatus according to claim 9, wherein selection of the data segment length comprises
determining a difference between time references that indicate relative playing time instants of data from mutually spaced points in the stream (20), the difference being indicative of a number of frames between the points, given a frame rate of the stream;
determining a total length of data between said points;
said computing comprising computing the selected length in proportion to a ratio of the total length and the number of frames between the points.

13. A method according to claim 7, comprising generating an intermediate stream that contains synthesized groups of pictures that each contain and data from a retrieved one of the first frames (22) and at least one synthesized further frame encoded in terms of update data for to the retrieved one of the first frames (22), the synthesized further frame defining substantially no update to the retrieved one of the first frames (22), the distance successive retrieved segments (26) being selected in proportion to a size of the synthesized groups of pictures.

14. Computer programme enabling a computer to be programmed to perform the method according to claim 1.

15. Carrier carrying the computer programme according to claim 14.
